(19) United States
(12) Patent Application Publication
(10) Pub. No.: US 2023/0177963 A1
(43) Pub. Date: Jun. 8, 2023

(54) Vehicle Control Apparatus and Vehicle Control Method Using the Same

(71) Applicants: Hyundai Motor Company, Seoul (KR); Kia Corporation, Seoul (KR)

(72) Inventor: Young Sung Joo, Hwaseong-si (KR)

(21) Appl. No.: 17/896,247

(22) Filed: Aug. 26, 2022

(30) Foreign Application Priority Data
Dec. 7, 2021 (KR) 10-2021-0174122

(51) Int. Cl. G08G 1/16; G08G 1/01; G08G 1/0967; G08G 1/052; G06N 3/04

(52) U.S. Cl. CPC G08G 1/167; G08G 1/166; G08G 1/0133; G08G 1/0141; G08G 1/096725; G08G 1/052; G06N 3/04

(57) ABSTRACT

An autonomous vehicle control method includes determining a congestion level of each of a plurality of lanes in a unit section of a certain area including the plurality of lanes, calculating a congestion level deviation between two lanes randomly selected among the plurality of lanes, and providing lane change guidance information to at least one vehicle of a plurality of vehicles scheduled to enter the unit section to reduce the congestion level deviation when the congestion level deviation is greater than or equal to a predetermined threshold.

### CROSS-REFERENCE TO RELATED APPLICATIONS

This application claims the benefit of Korean Patent Application No. 10-2021-0174122, filed on Dec. 7, 2021, which application is hereby incorporated herein by reference.

### TECHNICAL FIELD

The present disclosure relates to a vehicle control apparatus and a vehicle control method using the same.

### BACKGROUND

The main cause of traffic congestion is an increase in traffic volume. Because vehicles are temporarily stopped on national roads by traffic rules such as traffic lights in many cases, traffic congestion may occur frequently. Even on roads without traffic lights, such as highways and limited-access roads, traffic congestion may occur due to an increase in traffic volume during a specific time zone, maintenance construction on the road, or an accident on the road.

In the past, areas with severe traffic congestion were avoided based on traffic information obtained through the radio. However, recently, navigation has been used to find a route that takes the least time to a destination based on traffic information and location information.

Although it is possible to easily avoid places with severe traffic congestion by means of the navigation, the information provided by the navigation is based on the road. Thus, although the navigation is able to notify traffic congestion due to the amount of traffic on the entire road, there is no countermeasure for traffic congestion in specific lanes. For example, the navigation does not take any measures against changes in the number of lanes or congestion in a specific lane, such as an entrance ramp or an exit ramp. Furthermore, when a small contact accident occurs, the traffic congestion in the lane may suddenly explode.

As such, there is no countermeasure for traffic congestion occurring in some lanes. It is common for vehicles traveling in a congested lane to recognize that the lane is congested with respect to other lanes only after reaching the congested section. Particularly, when there is heavy congestion bias between lanes, a vicious cycle in which it is more difficult to get out of the congested lane due to the speed difference between the lanes occurs, and the risk of subsequent accidents increases.

Thus, there is a need for a method capable of quickly and more smoothly clearing congestion in some lanes.

### SUMMARY

The present disclosure relates to a vehicle control apparatus and a vehicle control method using the same. Particular embodiments relate to technologies capable of smoothly resolving a congestion environment of a specific lane due to a traffic congestion deviation between lanes.

Embodiments of the present disclosure can solve problems occurring in the prior art while advantages achieved by the prior art are maintained intact. [ooio] An embodiment of the present disclosure provides a vehicle control apparatus for preventing some lanes from becoming increasingly congested according to a road situation, an accident situation, and the like and a vehicle control method using the same. [ooii] Another embodiment of the present disclosure provides a vehicle control apparatus for resolving the congestion bias in some lanes and a vehicle control method using the same.

Another embodiment of the present disclosure provides a vehicle control apparatus for preventing congestion of the entire road from being increased due to congestion in some lanes and a vehicle control method using the same.

The technical problems to be solved by embodiments of the present disclosure are not limited to the aforementioned problems, and any other technical problems not mentioned herein will be clearly understood from the following description by those skilled in the art to which the present disclosure pertains.

According to an embodiment of the present disclosure, a vehicle control method may include determining a congestion level of each of a plurality of lanes, in a unit section of a certain area including the plurality of lanes, calculating a congestion level deviation between two lanes randomly selected among the plurality of lanes, and providing lane change guidance information to at least one of vehicles scheduled to enter a road to reduce the congestion level deviation, based on that the congestion level deviation is greater than or equal to a predetermined threshold.

According to an embodiment of the present disclosure, the determining of the congestion level may include setting a default value to be inversely proportional to an average speed of vehicles traveling on any lane in the unit section, setting a weight capable of affecting the congestion level, and reflecting the weight in the default value.

According to an embodiment of the present disclosure, the setting of the weight may include setting the weight to be inversely proportional to an average speed of vehicles passing through the unit section.

According to an embodiment of the present disclosure, the setting of the weight may include setting the weight to be proportional to the number of vehicles passing through the unit section.

According to an embodiment of the present disclosure, the setting of the weight may include identifying a lane blocking event where the lane is blocked in the unit section and setting a weight of a lane where the lane blocking event occurs to be higher than weights of the other lanes.

According to an embodiment of the present disclosure, the setting of the weight may include adding the highest congestion level to the lane where the lane blocking event occurs and adding a lower congestion level as a distance from the lane where the lane blocking event occurs is increased.

According to an embodiment of the present disclosure, the setting of the weight may include setting weights of a lane where the number of lanes is reduced in the unit section and a merging lane to be large.

According to an embodiment of the present disclosure, the setting of the weight may include performing artificial intelligence learning of at least one of pieces of information about an average speed of vehicles passing through the unit section, the number of the vehicles passing through the unit section, a lane blocking event where the lane is blocked in the unit section, or a lane where the number of lanes is reduced in the unit section and a merging lane and extracting the weight.

According to an embodiment of the present disclosure, the providing of the lane change guidance information may include providing the lane change guidance information to an autonomous vehicle preferentially rather than a non-autonomous vehicle.

According to an embodiment of the present disclosure, the providing of the lane change guidance information may include determining an expected speed of each of vehicles passing through the unit section based on lane change control of the autonomous vehicle and requesting a driver of the non-autonomous vehicle to make a lane change, based on that the expected speed is less than a target speed.

According to an embodiment of the present disclosure, the providing of the lane change guidance information may further include awarding a user reward to the driver of the non-autonomous vehicle, the lane change of which is completed in response to the request for the lane change. The requesting the driver of the non-autonomous vehicle to make the lane change may include preferentially requesting a driver with a high score according to the user reward to make the lane change.

According to an embodiment of the present disclosure, the determining of the congestion level may include calculating a first congestion level at a first timing and adding an offset obtained by reflecting a depreciation rate in a second congestion level prior to the first timing t0 the first congestion level.

According to another embodiment of the present disclosure, a vehicle control apparatus may include a communication device that receives traffic information about a unit section of a certain area including a plurality of lanes, a congestion level calculation device that searches for road information stored in a database, determines a congestion level of each of the lanes which belongs to the unit section based on the traffic information and the road information, and calculates a congestion level deviation between two lanes randomly selected among the lanes, and a lane change logic device that provides lane change guidance information to at least one of vehicles scheduled to enter a road to reduce the congestion level deviation, based on that the congestion level deviation is greater than or equal to a predetermined threshold.

According to an embodiment of the present disclosure, the congestion level calculation device may set a default value to be inversely proportional to an average speed of vehicles traveling on any lane in the unit section, may set a weight capable of affecting the congestion level, and may reflect the weight in the default value to calculate the congestion level.

According to an embodiment of the present disclosure, the congestion level calculation device may identify a lane blocking event where the lane is blocked in the unit section and may set a weight of a lane where the lane blocking event occurs to be higher than weights of the other lanes.

According to an embodiment of the present disclosure, the congestion level calculation device may set weights of a lane where the number of lanes is reduced in the unit section and a merging lane to be large.

According to an embodiment of the present disclosure, the congestion level calculation device may perform artificial intelligence learning of at least one of pieces of information about an average speed of vehicles passing through the unit section, the number of the vehicles passing through the unit section, a lane blocking event where the lane is blocked in the unit section, or a lane where the number of lanes is reduced in the unit section and a merging lane and may extract the weight.

According to an embodiment of the present disclosure, the lane change logic device may provide the lane change guidance information to an autonomous vehicle preferentially rather than a non-autonomous vehicle.

According to an embodiment of the present disclosure, the lane change logic device may award a user reward to a driver of the non-autonomous vehicle, a lane change of which is completed in response to a request for the lane change and may preferentially provide the lane change guidance information to a driver with a high score according to the user reward when requesting the driver of the non-autonomous vehicle to make a lane change.

According to an embodiment of the present disclosure, the congestion level calculation device may calculate a first congestion level at a first timing and may add an offset obtained by reflecting a depreciation rate in a second congestion level prior to the first timing t0 the first congestion level.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a diagram illustrating a vehicle control method according to an embodiment of the present disclosure;

FIG. 2 is a drawing illustrating a communication means for vehicle control according to an embodiment of the present disclosure;

FIG. 3 is a block diagram illustrating a configuration of a server;

FIG. 4 is a block diagram illustrating a configuration of a non-autonomous vehicle;

FIG. 5 is a block diagram illustrating a configuration of an autonomous vehicle;

FIG. 6 is a flowchart illustrating a vehicle control method according to an embodiment of the present disclosure;

FIG. 7 is a flowchart illustrating a method for calculating a congestion level according to an embodiment of the present disclosure;

FIG. 8 is a drawing illustrating an embodiment of setting a third threshold depending on a lane blocking event;

FIG. 9 is a drawing illustrating an embodiment of setting a fourth threshold in a section where the number of lanes is reduced;

FIG. 10 is a drawing illustrating an embodiment of setting a fourth threshold in an exit section;

FIG. 11 is a diagram illustrating a lane change guidance method according to an embodiment of the present disclosure;

FIG. 12 is a flowchart illustrating a lane change guidance method according to an embodiment of the present disclosure;

FIG. 13 is a simulation result illustrating that a congestion level deviation is enhanced based on guidance on a lane change according to an embodiment of the present disclosure; and

FIG. 14 is a block diagram illustrating a computing system according to an embodiment of the present disclosure.

### DETAILED DESCRIPTION OF ILLUSTRATIVE EMBODIMENTS

Hereinafter, some embodiments of the present disclosure will be described in detail with reference to the accompanying drawings. In adding the reference numerals to the components of each drawing, it should be noted that the identical components are designated by the identical numerals even when they are displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

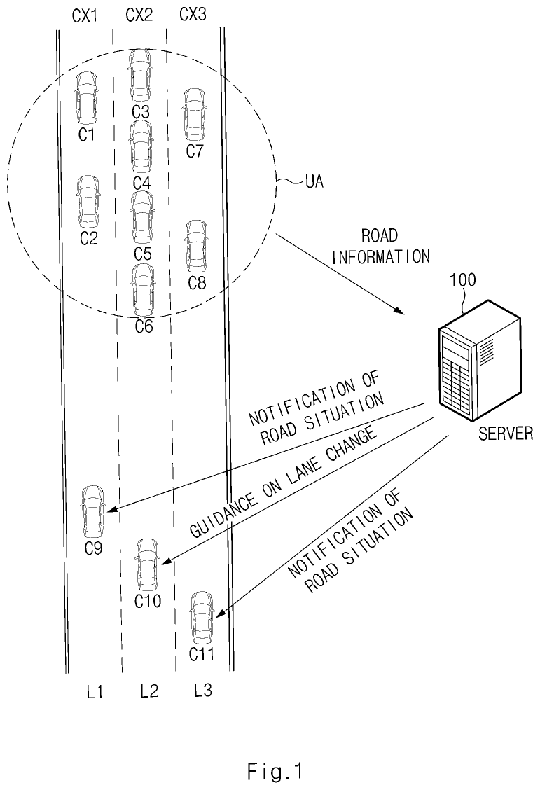

Hereinafter, embodiments of the present disclosure will be described in detail with reference to FIGS. 1 to 14.

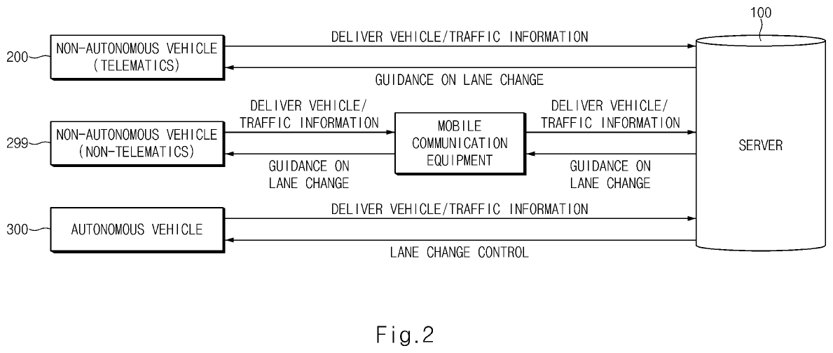

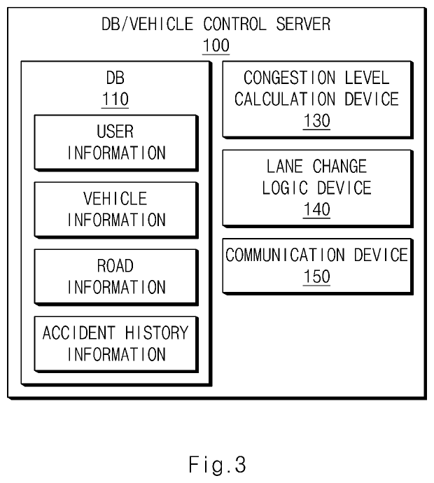

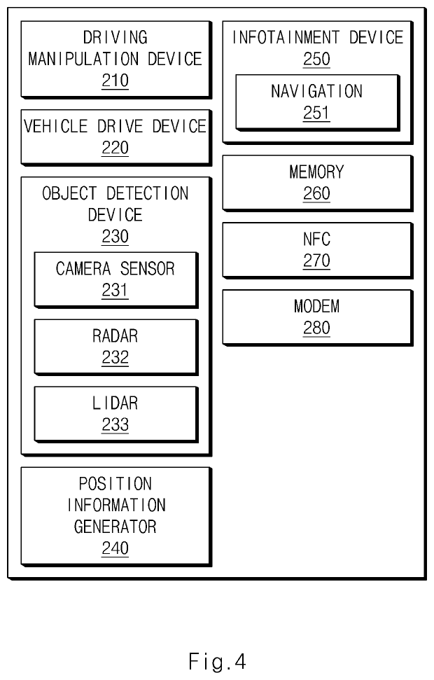

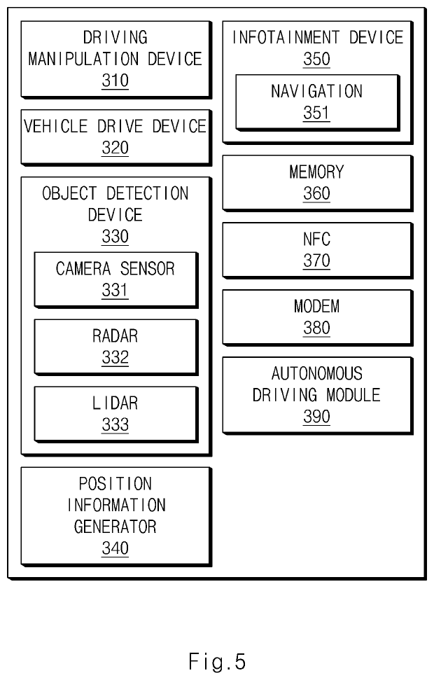

FIG. 1 is a diagram illustrating a vehicle control method according to an embodiment of the present disclosure. FIG. 2 is a drawing illustrating a communication means for vehicle control according to an embodiment of the present disclosure. FIG. 3 is a block diagram illustrating a configuration of a server. FIG. 4 is a block diagram illustrating a configuration of a non-autonomous vehicle. FIG. 5 is a block diagram illustrating a configuration of an autonomous vehicle.

The vehicle control method and components of a vehicle control system according to an embodiment of the present disclosure will be described with reference to FIGS. 1 to 5.

As shown in FIG. 1, the vehicle control method according to an embodiment of the present disclosure may be to monitor a congestion level of a unit section UA and to guide vehicles C9 to C11 to enter the unit section UA to make a lane change based on the congestion level. The unit section UA may be a section which is a criterion of calculating a congestion level and may be an area which belongs to a certain radius with respect to position coordinates. The congestion level may be defined as a factor capable of affecting a speed of each of the vehicles scheduled to pass through any lane. In other words, the congestion level in the specification may be separately determined for each of the lanes in the unit section UA. For example, a congestion level of a first lane L1 may be obtained as CX1, a congestion level of a second lane L2 may be obtained as CX2, and a congestion level of a third lane L3 may be obtained as CX3.

According to an embodiment of the present disclosure, the vehicle control method may be to guide the vehicles C9 to C11 to make a lane change based on a congestion deviation between the respective lanes. For example, because there are many vehicles passing through the second lane L2 in the unit section UA, when CX2 is greater than CX1 or CX3, a server 100 may guide the vehicle C10 heading for the unit section UA in the second lane L2 to make a lane change to prevent the congestion in the unit section UA from increasing. Furthermore, the server 100 may notify the vehicles C9 and C11 heading for the unit section UA in the first lane L1 and the third lane L3 of a road situation in front of the vehicles C9 and C11, thus guiding the vehicles C9 and C11 to keep the first lane L1 and the third lane L3, respectively.

To identify road information of the unit section UA, the server 100 may communicate with the vehicles C1 to C8 passing through the unit section UA. The vehicles may include non-autonomous vehicles 200 and 299 or an autonomous vehicle 300. The non-autonomous vehicles may include the telematics vehicle 200 having a telematics function and the general vehicle 299 which does not have the telematics function. Telematics may refer to a compound word of telecommunication and informatics and may refer to a wireless Internet service in which a vehicle and wireless communication are combined with each other.

The server 100 may receive vehicle and traffic information, based on the wireless Internet service of a telematics vehicle 200. Furthermore, the server 100 may receive vehicle and traffic information from the general vehicle 299 through relay of mobile communication equipment. The mobile communication equipment may be a portable terminal of a driver of the general vehicle 299. Furthermore, the server 100 may receive vehicle and traffic information from the autonomous vehicle 300.

The server 100 may determine a congestion level of the unit section based on traffic information provided from the vehicles. To this end, the server 100 may include a database (DB) no, a congestion level calculation device 130, a lane change logic device 140, and a communication device 150. The DB 110 of the server 100 may store information provided from vehicles or other servers. The server 100 may store user information, vehicle information, road information, and accident history information in the DB no. The user information may include information about a driver of the vehicle and may include information about a user reward rewarded in response to guidance on a lane change. The vehicle information may be stored by being matched with driver information and may include information about a vehicle type such as an autonomous vehicle or a telematics vehicle. The road information may include information such as a type of the road, the number of lanes, a merging section, a fork, an intersection, an entrance ramp, or an exit ramp. The accident history information may include information about an accident which occurs on the road.

The congestion level calculation device 130 may search the DB 110 for vehicle information, road information, and accident history information and may calculate a congestion level of each of the lanes in the unit section UA based on the found information.

The lane change logic device 140 may determine whether it is necessary for each of the vehicles heading for the unit section UA to make a lane change based on the congestion level. When it is necessary to guide each of the vehicles to make a lane change, the lane change logic device 140 may transmit a guidance message for guidance on the lane change to the vehicles through the communication device 150. Furthermore, when a vehicle targeted at guidance on a lane change is an autonomous vehicle, the lane change logic device 140 may generate a control signal for controlling the autonomous vehicle.

The communication device 150 may perform wireless communication with another server or a modem of the vehicle to receive traffic information about the unit section. The communication device 150 may transmit and receive a wireless signal with a modem 280 of a non-autonomous vehicle or a modem 380 of an autonomous vehicle over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like). The wireless signal may include a voice call signal, a video call signal, or various types of data according to text/multimedia message transmission and reception.

Referring to FIG. 4, the non-autonomous vehicle may include a driving manipulation device 210, a vehicle drive device 220, an object detection device 230, a position information generator 240, an infotainment device 250, a memory 260, near field communication (NFC) 270, and the modem 280.

The driving manipulation device 210 may be a device which receives a user input for driving. The driving manipulation device 210 may include a steering input device, such as a steering wheel, an accelerator pedal, a brake pedal, and the like.

The vehicle drive device 220 may control various drive devices in the vehicle and may include a powertrain drive device, a chassis drive device, a door/window drive device, a safety part drive device, a lamp drive device, and an air conditioning drive device. The powertrain drive device may include a power source drive device and a transmission drive device. The chassis drive device may include a steering drive device, a brake drive device, and a suspension drive device. The safety part drive device may include a seat belt drive device for controlling a seat belt. The vehicle drive device 220 may include an electronic control unit (ECU).

The object detection device 230 may generate information about an object inside the vehicle or an object outside the vehicle. The object detection device 230 may include at least one of information about whether there is an object, information about a position of the object, information about a distance between the vehicle and the object, or information about a relative speed between the vehicle and the object. The object detection device 230 may include one or more sensors capable of detecting an object. For example, the object detection device 230 may include a camera sensor 231, a radar 232, a light detection and ranging (LiDAR) 233, and the like.

The position information generator 240 may generation position data of the vehicle. The position information generator 240 may include at least one of a global positioning system (GPS) or a differential global positioning system (DGPS). The position information generator 240 may generate position data based on a signal generated by at least one of the GPS or the DPGS. The position information generator 240 may be referred to as a global navigation satellite system (GNSS).

The infotainment device 250 may include a navigation 251 for guidance on a driving route and may include a device for entertainment, for example, an audio or a video, or the like.

The memory 260 may be connected with a processor, an electronic control device, or the like for controlling the vehicle and may store various programs for controlling the vehicle and various pieces of data for operations of the programs.

The NFC 270 may include an NFC tag including vehicle identification information for accessing a telematics unit of the vehicle.

The modem 280 may communicate with the server 100 in such a manner as to modulate and transmit a digital signal into an analog signal and demodulate the received analog signal into a digital signal.

Referring to FIG. 5, the autonomous vehicle may include a driving manipulation device 310, a vehicle drive device 320, an object detection device 330, a position information generator 340, an infotainment device 350, a memory 360, NFC 370, a modem 380, and an autonomous driving module 390. In FIG. 5, because the driving manipulation device 310, the vehicle drive device 320, the object detection device 330, the position information generator 340, the infotainment device 350, the memory 360, the NFC 370 and the modem 380 are able to be implemented to be substantially the same as the above-mentioned components of the non-autonomous vehicle, a detailed description thereof will be omitted.

The autonomous driving module 390 may generate a driving route for autonomous driving and may generate a driving plan for traveling along the generated driving route. The autonomous driving module 390 may generate a signal for controlling motion of the vehicle and may provide the vehicle drive device 320 with the generated signal. Furthermore, the autonomous driving module 390 may receive a lane change control signal from the server 100 or may generate a control signal for a lane change based on lane change guidance information provided from the server 100.

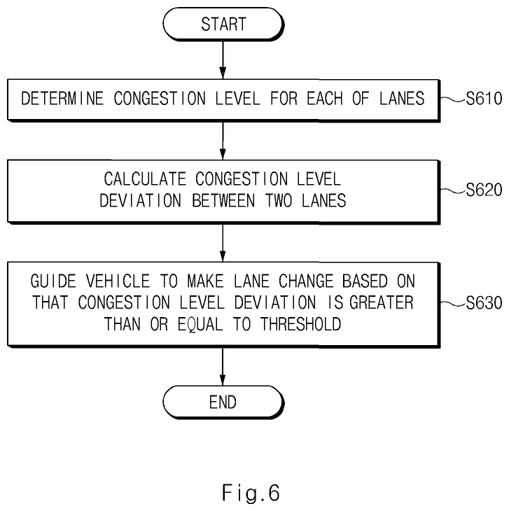

FIG. 6 is a flowchart illustrating a vehicle control method according to an embodiment of the present disclosure.

A description will be given in detail of a vehicle control method according to an embodiment of the present disclosure with reference to FIGS. 1 and 6. A procedure shown in FIG. 6 will be described with respect to an embodiment performed by a server 100 of FIG. 3.

In S610, a congestion level calculation device 130 of the server 100 may determine a congestion level of each of the lanes.

As described with reference to FIG. 1, a congestion level of a unit section UA at a first timing may not be a factor affecting speeds of vehicles C1 to C8 passing through the unit section UA at the first timing and may be a factor affecting speeds of vehicles C9 to C11 scheduled to pass through the unit section UA after the first timing.

The congestion level in an embodiment of the present disclosure may particularly refer to a degree to which it may cause deceleration. In other words, in an embodiment of the present disclosure, as the magnitude of the congestion level is large, it may be predicted that vehicles scheduled to travel in a corresponding lane will travel at a low speed. The congestion level may be separately obtained for each of the lanes.

In S620, the congestion level calculation device 130 of the server 100 may calculate a congestion deviation between two of the lanes. To this end, the congestion level calculation device 130 may extract a combination of two of a plurality of lanes. In other words, the congestion level calculation device 130 may extract combinations corresponding to nC2 for n (where n is a natural number) lanes. As shown in FIG. 1, when there are three lanes, the congestion level calculation device 130 may extract three combinations. Each of the combinations may include first and second lanes L1 and L2, first and third lanes L1 and L3, and second and third lanes L2 and L3.

The congestion level calculation device 130 may calculate a congestion deviation between lanes which belong to each combination. For example, the congestion deviation between the first and second lanes L1 and L2 may be calculated as (CX1−CX2), the congestion deviation between the first and third lanes L1 and L3 may be calculated as (CX1−CX3), and the congestion deviation between the second and third lanes L2 and L3 may be calculated as (CX2−CX3). In an embodiment, the congestion level calculation device 130 may calculate each congestion deviation as an absolute value.

In S630, a lane change logic device 140 of the server 100 may guide a vehicle to make a lane change, based on that the congestion deviation is greater than or equal to a predetermined threshold. The guiding of the vehicle to make the lane change may include providing the vehicle with lane change guidance information through a communication device 150 of FIG. 3. The lane change guidance information may be a lane change control signal or a lane change guidance message. Furthermore, the lane change logic device 140 may transmit congestion section information to another vehicle except for the vehicle which is a lane change target and may transmit a message guiding the other vehicle to keep a corresponding lane to the other vehicle.

The lane change logic device 140 may set the number of vehicles which are targets to be guided to make a lane change or control a lane change, depending on the congestion deviation. For example, the larger the congestion deviation, the higher the lane change logic device 140 may set the number of vehicles to be guided to make a lane change to be.

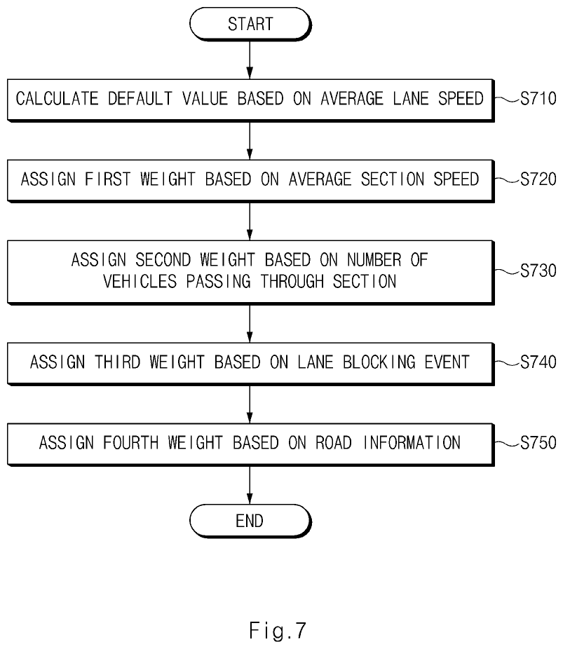

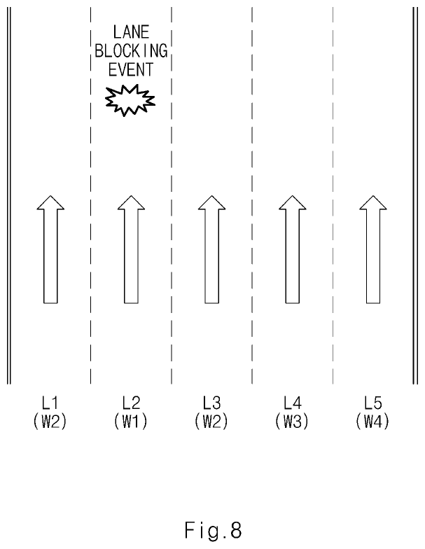

FIG. 7 is a flowchart illustrating a method for calculating a congestion level according to an embodiment of the present disclosure. FIGS. 8 to 10 are drawings illustrating a method for setting a weight in FIG. 7. FIG. 7 may correspond to an embodiment of S610 shown in FIG. 6 and may be a procedure performed by a congestion level calculation device 130 of a server 100 of FIG. 3.

The method for calculating the congestion level according to an embodiment of the present disclosure will be described with reference to FIG. 7. The method for calculating the congestion level may include calculating a default value and assigning a weight to the default value. S710 in FIG. 7 describes calculating the default value. S720 to S750 in FIG. 7 describe assigning the weights. The assigning of the weights may include at least one of S720, S730, S740, or S750. Alternatively, the assigning of the weights may include various embodiments with regard to a factor capable of degrading movement speeds of vehicles.

In S710, the congestion level calculation device 130 may calculate a default value based on an average lane speed.

In the specification, the average lane speed may refer to an average speed of vehicles passing through one lane in a unit section. The average lane speed may be calculated for each of the lanes. For example, as shown in FIG. 1, a default value for a first lane L1 in a unit section UA may be calculated based on an average speed of a first vehicle C1 and a second vehicle C2. Similarly, a default value for a second lane L2 may be calculated based on an average speed of third to sixth vehicles C3 to C6. Furthermore, a default value for a third lane L3 may be calculated based on an average speed of seventh and eighth vehicles C7 and C8.

The default value may be set to be inversely proportional to the average lane speed. In other words, the slower the average lane speed, the larger the default value may be set to be. The default value and the average lane speed may have a linear relationship or may have a non linear relationship such as an exponential function form or a log function form.

In S720, the congestion level calculation device 130 may assign a first weight based on an average speed of vehicles which travel on all lanes.

In the specification, the average lane speed may refer to an average speed of all vehicles passing through a unit section. For example, the average speed in the unit section may be an average speed of vehicles C1 to C8 which are traveling on the unit section UA as shown in FIG. 1.

Because there is a high possibility that a congestion phenomenon will become severe in a slow section, the first weight may be set to be inversely proportional to the average section speed. In other words, the slower the average section speed, the larger the first weight may be set to be. The first weight and the average section speed may have a linear relationship or may have a non-linear relationship such as an exponential function form or a log function form.

In S730, the congestion level calculation device 130 may assign a second weight based on the number of vehicles passing through a section. The number of the vehicles passing through the section may refer to the number of vehicles which are traveling on the unit section. For example, the number of vehicles passing through the section in FIG. 1 may include first to eighth vehicles C1 to C8 which are traveling on the unit section UA.

Because the larger the number of vehicles passing through the unit section, the greater the speed change, the second weight may be set to be proportional to the number of vehicles passing through the section. In other words, the larger the number of vehicles passing through the section, the larger the second weight may be set to be. The second weight and the average section speed may have a linear relationship or may have a non-linear relationship such as an exponential function form or a log function form.

In S740, the congestion level calculation device 130 may assign a third weight based on a lane blocking event.

The lane blocking event may refer to a state where it is impossible to temporarily pass through a lane and may refer to a state where there is a possibility of being recovered after a certain time. For example, the lane blocking event may be a state where the lane is temporarily blocked due to road construction. Furthermore, the lane blocking event may be a state where it is unable to pass through the lane due to occurrence of an accident or accident handling.

FIG. 8 is a drawing illustrating an embodiment of setting a third threshold depending on a lane blocking event.

Referring to FIG. 8, a congestion level calculation device 130 of FIG. 3 may assign a third weight of one of W1 to W4 to first to fifth lanes L1 to L5. The third weight for the second lane L2 where the lane blocking event occurs may be set to W1 with the largest magnitude. The third weight for the first lane L1 and the third lane L3, which are adjacent to the second lane L2, may be set to W2 with a magnitude smaller than W1. Furthermore, the third weight for the fourth lane L4 adjacent to the third lane L3 in a direction opposite to the first lane L1 may be set to W3 with the magnitude smaller than W2. The third weight for the fifth lane L5 located furthest away from the first lane L1 may be set to W4 with the smallest magnitude.

In S750, the congestion level calculation device 130 may assign a fourth weight based on road information.

The road information used to set the fourth threshold may be a section where the number of lanes is reduced. Furthermore, the road information used to set the fourth weight may be a section, such as an entrance ramp or an exit ramp, which is able to aggravate congestion.

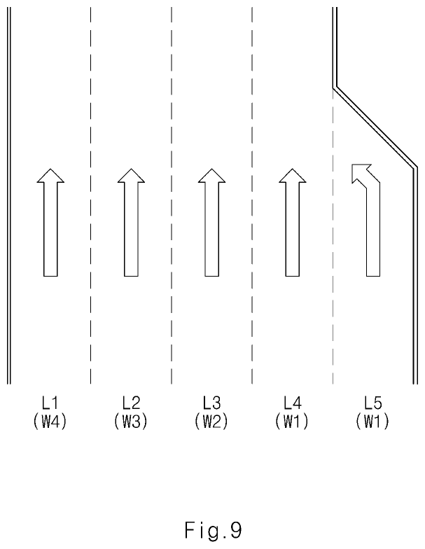

FIG. 9 is a drawing illustrating an embodiment of setting a fourth threshold in a section where the number of lanes is reduced.

Referring to FIG. 9, a congestion level calculation device 130 of FIG. 3 may assign a fourth weight of one of W1 to W4 to first to fifth lanes L1 to L5. The fourth weight for the fifth lane L5, which is cut off due to lane reduction, and the fourth lane L4 where vehicles in the fifth lane L5 merge may be set to W1 with the largest magnitude. The fourth weight for the third lane L3 adjacent to the fourth lane L4 may be set to W2 with a magnitude smaller than W1. Furthermore, the fourth weight for the second lane L2 adjacent to the third lane L3 in a direction opposite to the fourth lane L4 may be set to W3 with the magnitude smaller than W2. The fourth weight for the first lane L1 located furthest away from the fourth lane L4 may be set to W4 with the smallest magnitude.

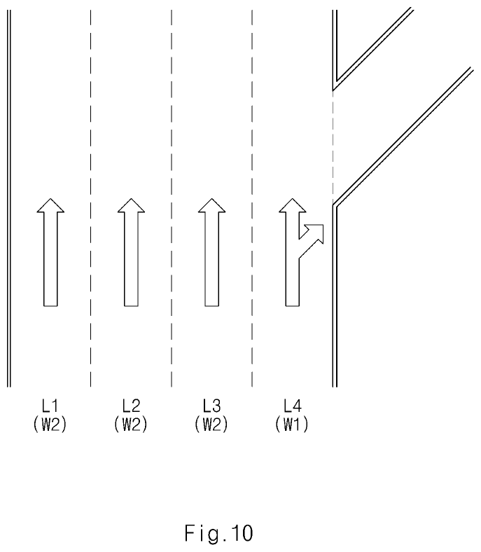

FIG. 10 is a drawing illustrating an embodiment of setting a fourth threshold in an exit section.

Referring to FIG. 10, a congestion level calculation device 130 of FIG. 3 may assign a fourth weight selected from W1 or W2 to first to fourth lanes L1 to L4. The fourth lane L4 which provides a route entering an exit ramp with a high congested frequency has a high possibility of causing congestion. Thus, the fourth weight of the fourth lane L4 may be set to W1 with the largest magnitude. Because the first to third lanes L1 to L3 may hardly be affected by the congestion of the fourth lane L4, the fourth weight may be set to W2 with a magnitude smaller than W1.

In an embodiment shown in FIG. 7, a procedure of setting a weight may be accomplished based on artificial intelligence (AI) learning. For example, a server 100 may include an AI processor for extracting a weight. The AI processor may learn a neural network using a previously stored program. The neural network for extracting a weight may include a plurality of network nodes having weights, which may be designed to simulate a human brain structure on the computer and may simulate neurons of the human neural network. The plurality of network nodes may transmit and receive data depending on each connection relationship to simulate the synaptic activity of neurons which transmit and receive signals through the synapse. The neural network may include a deep learning model developed from a neural network model. A plurality of network nodes in the deep learning model may be located on different layers to transmit and receive data depending on a convolution connection relationship. An example of the deep learning model may include various deep learning techniques such as deep neural networks (DNN), convolutional deep neural networks (CNN), a recurrent Boltzmann machine (RNN), a restricted Boltzmann machine (RBM), deep belief networks (DBN), and a deep Q-network.

The AI processor may perform AI learning of at least one of pieces of information about an average speed of vehicles, the number of vehicles passing through a unit section, a lane blocking event where a lane is blocked in the unit section, and a lane where the number of lanes is reduced in the unit section and a merging lane. The AI processor may extract a weight as the result of learning.

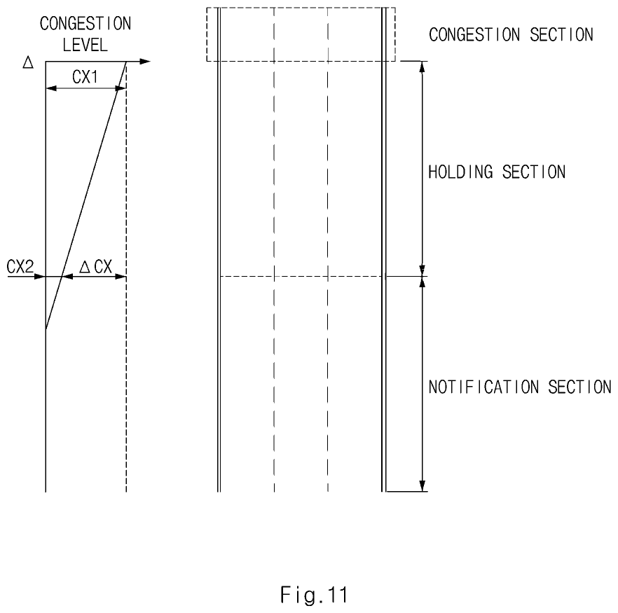

FIG. 11 is a diagram illustrating a lane change guidance method according to an embodiment of the present disclosure.

Referring to FIG. 11, in an embodiment of the present disclosure, a lane change logic device 140 of FIG. 3 may set a holding section and a notification section and may transmit a message for guidance on a lane change to vehicles which are traveling on the notification section.

A congestion section may be a unit section where the necessity of a lane change of each of the vehicles entering the section is required based on a congestion level.

The holding section may be a section close to the congestion section and may be a section where a lane change guidance procedure is omitted. Drivers of vehicles which are traveling on the holding section may identify the congestion section. Furthermore, when vehicles close to the congestion section suddenly depart from the lane, this may cause even more confusion. Thus, vehicles which are traveling on the holding section may not receive a separate notification for guidance on a lane change.

The notification section may be a section which belongs to a certain range in a distance spaced apart from the congestion section by the holding section.

The holding section and the notification section may be set based on an average congestion level. The average congestion level may be obtained by averaging congestion levels of respective lanes which belong to the congestion section.

The lane change logic device 140 may set the notification section to be long in proportion to the average congestion.

The lane change logic device 140 may set the holding section based on a deviation of the average congestion level. As the distance from the congestion section increases, the average congestion level may tend to decrease. FIG. 11 illustrates an embodiment where the average congestion level of the congestion section is CX_E1 and where the average congestion level of a notification section start point is CX_E2. Because congestion is able to become worse when there are many vehicles which make lane changes at a point close to the congestion section, the lane change logic device 140 may set a time when the average congestion level is reduced to a start point of the notification section.

Thus, to calculate an average congestion level deviation, the lane change logic device 140 may calculate an average congestion level of the congestion section and may calculate an average congestion of each of the unit sections on roads heading for the congestion section. The lane change logic device 140 may calculate an average congestion level of the congestion section and an average congestion deviation between random unit sections. The lane change logic device 140 may set a unit section, the average congestion level deviation with the congestion section of which causes more than a threshold, to the start point of the notification section.

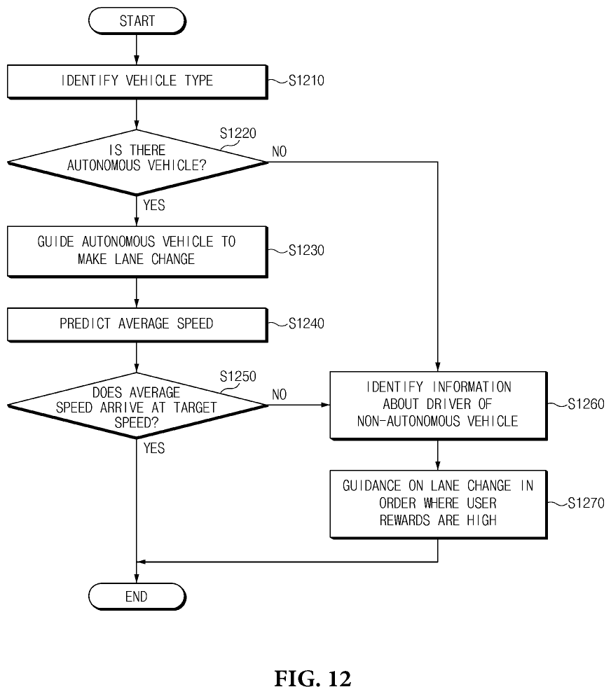

FIG. 12 is a flowchart illustrating a lane change guidance method according to an embodiment of the present disclosure.

The lane change guidance method according to an embodiment of the present disclosure will be described with reference to FIG. 12.

In S1210, a lane change logic device 140 of FIG. 3 may identify a vehicle type. The lane change logic device 140 may identify pieces of vehicle information of vehicles which are traveling on a notification section.

In S1220, the lane change logic device 140 may determine whether there is an autonomous vehicle.

When there is the autonomous vehicle in the notification section, in S1230, the lane change logic device 140 may preferentially guide the autonomous vehicle to make a lane change. According to an embodiment, the lane change logic device 140 may change a lane of any autonomous vehicle in the notification section.

In S1240, the lane change logic device 140 may predict an average speed of the congestion section by means of lane change control. The average speed may refer to an average speed of vehicles to pass through the congestion section.

In S1250, the lane change logic device 140 may determine whether the average speed arrives at a target speed. In other words, in S1240 and S1250, the lane change logic device 140 may determine whether it is able to resolve the congestion of the congestion section when proceeding with making a lane change of each of the autonomous vehicles in the notification section.

When the predicted average speed arrives at the target speed, the lane change logic device 140 may end a lane change guidance procedure.

When the autonomous vehicle is not found in the congestion section, in S1260, the lane change logic device 140 may identify information about a driver of a non-autonomous vehicle in the congestion section. In S1270, the lane change logic device 140 may search for a driver with a high user reward, based on pieces of information about drivers of non-autonomous vehicles, and may attempt to perform guidance on a lane change in an order where user rewards are high. The user reward is rewarded to a driver who completes a lane change in response to a lane change request, which may be applied to a business model.

In other words, according to an embodiment of the present disclosure, the guiding of the lane change may further include rewarding a user reward to a driver of a non-autonomous vehicle which completes a lane change in response to the lane change request. When guidance on a lane change is required later, a priority may be set with respect to the user reward. Because it is estimated that the high user reward means that the frequency of responding to the guidance on the lane change is high, the guidance on the lane change may more smoothly proceed according to an embodiment of the present disclosure.

The method for determining the congestion level according to an embodiment of the present disclosure may include reflecting congestion obtained at a previous timing. For example, the method for determining the congestion level according to an embodiment of the present disclosure may be to calculate a total congestion level at a first timing by calculating a first congestion level at the first timing and adding an offset obtained by reflecting a depreciation rate in a second congestion level prior to the first timing t0 the first congestion level. In other words, the total congestion level CXt_t0 at timing t0 may be calculated as Equation 1 below.

CXt_t0=CX_t0+rCXt_(t−1)+r²CXt_(t−2)+ . . . r^{k}CXt_(t−k)=Σₖ₌₀^{j}r^{k}CXt_(t−k) Equation 1

In Equation 1 above, Cx_t0 may be the congestion level obtained at timing t0 and may be obtained as described with reference to FIGS. 6 to 11.

r may be the depreciation rate and may be set within a range which is an integer greater than 0 and less than 1. r^{k}CXt_(t−k) refers to the total congestion level at timing (t−k), where k is a natural number of j or less. In other words, (t−k) may refer to a timing prior to timing t0. j may determine the number of terms reflected to calculate the total congestion level Cxt_t0 at timing t0. r^{j} may converge to 0 as the number of j increases.

In Equation 1 above, because the congestion level according to an embodiment of the present disclosure reflects a congestion level at a previous timing, the congestion level of the unit section may more accurately reflect an influence on the notification section. For example, the congestion occurring in the unit section may affect a holding section, and the congestion of the holding section may persist to some extent after the congestion of the unit section is resolved.

Thus, an embodiment of the present disclosure may calculate a total congestion level by reflecting a congestion level at a previous timing, thus reflecting a congestion level of a congestion state during a certain time although the congestion of the unit section is resolved.

A server 100 according to an embodiment of the present disclosure may calculate an expected value prior to a lane change and may obtain a measurement value after the lane change. The expected value may be calculated before the lane change is performed and may be an average section speed of the unit section UA predicted to make a lane change. Because the procedure of performing guidance on a lane change in an embodiment of the present disclosure is to minimize a congestion level deviation, the expected value may be an average section speed of the unit section UA before performing the guidance on the lane change. The measurement value may be an average section speed measured in the unit section UA when the lane change is accomplished.

The server 100 may compare the expected value with the average section speed after the lane change to determine reliability of a lane change guidance algorithm of the lane change logic device 140. In other words, as the measurement value is smaller than the expected value, the server 100 may determine the reliability of the lane change guidance algorithm to be low. Furthermore, as the measurement value is close to the expected value or as the measurement value is larger than the expected value, the server 100 may evaluate the reliability of the lane change guidance algorithm to be high. Furthermore, the server 100 may change a subsequent lane change guidance procedure based on the reliability of the lane change guidance algorithm.

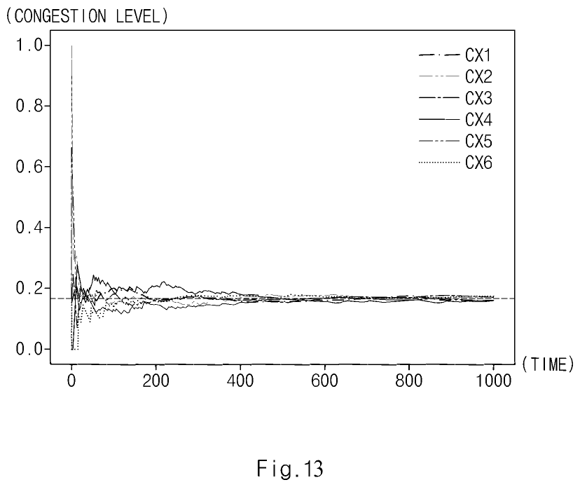

FIG. 13 is a simulation result illustrating that a congestion level deviation is enhanced based on guidance on a lane change according to an embodiment of the present disclosure.

FIG. 13 illustrates a change in congestion level of each of first to sixth lanes. CX1 denotes the congestion level of the first lane, CX2 denotes the congestion level of the second lane, CX3 denotes the congestion level of the third lane, CX4 denotes the congestion level of the fourth lane, CX5 denotes the congestion level of the fifth lane, and CX6 denotes the congestion level of the sixth lane.

As shown in FIG. 13, it may be seen that the congestion level of each of the first to sixth lanes initially shows a large deviation, but the congestion level deviation decreases as time passes. In other words, according to an embodiment of the present disclosure, vehicles in all lanes may maintain a speed of the same level.

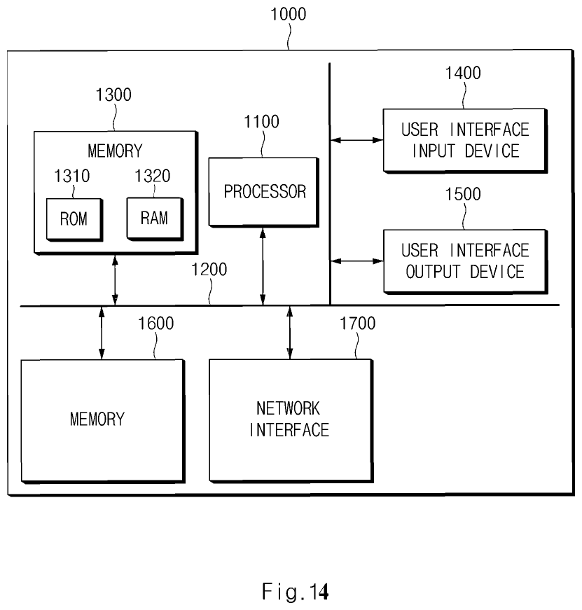

FIG. 14 is a block diagram illustrating a computing system according to an embodiment of the present disclosure. The computing system shown in FIG. 14 may be an entity which supervises guidance on a lane change.

Referring to FIG. 14, a computing system woo may include at least one processor 1100, a memory 1300, a user interface input device 1400, a user interface output device 1500, a memory (i.e., a storage) 1600, and a network interface 1700, which are connected with each other via a bus 1200.

The processor 1100 may be a central processing unit (CPU) or a semiconductor device that processes instructions stored in the memory 1300 and/or the memory 1600. The processor 1100 may include a service operation controller which performs a connected service operation depending on the result of processing the service request of a modem. Particularly, the processor 1100 may include components, such as a congestion level calculation device and a lane change logic device, to perform some functions of a server shown in FIG. 3.

The memory 1300 and the memory 1600 may include various types of volatile or non-volatile storage media. For example, the memory 1300 may include a ROM (Read Only Memory) 1310 and a RAM (Random Access Memory) 1320.

Thus, the operations of the methods or the algorithms described in connection with the embodiments disclosed herein may be embodied directly in hardware or a software module executed by the processor 1100, or in a combination thereof. The software module may reside on a storage medium (that is, the memory 1300 and/or the memory 1600) such as a RAM, a flash memory, a ROM, an EPROM, an EEPROM, a register, a hard disk, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an embodiment of the present disclosure, the vehicle control apparatus may prevent congestion from accelerating by quickly changing lanes of following vehicles when the congestion of the lane occurs.

Furthermore, according to an embodiment of the present disclosure, the vehicle control apparatus may reduce a risk that a subsequent accident may occur by guiding a vehicle to make a lane change to an area departing from a severe congestion section.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A vehicle control method comprising:
determining a congestion level of each of a plurality of lanes in a unit section of a certain area including the plurality of lanes;
calculating a congestion level deviation between two lanes randomly selected among the plurality of lanes; and
providing lane change guidance information to at least one vehicle of a plurality of vehicles scheduled to enter the unit section to reduce the congestion level deviation when the congestion level deviation is greater than or equal to a predetermined threshold.

2. The vehicle control method of claim 1, wherein providing the lane change guidance information comprises providing the lane change guidance information to an autonomous vehicle preferentially over a non-autonomous vehicle.

3. The vehicle control method of claim 2, wherein providing the lane change guidance information comprises:
determining an expected speed of each of the vehicles passing through the unit section based on a lane change control of the autonomous vehicle; and
requesting a driver of the non-autonomous vehicle to make a lane change based on the expected speed being less than a target speed.

4. The vehicle control method of claim 3, wherein:
providing the lane change guidance information further comprises awarding a user reward to the driver of the non-autonomous vehicle who completes the lane change in response to the request for the lane change; and
requesting the driver of the non-autonomous vehicle to make the lane change comprises requesting a driver with a high score according to the user reward preferentially to make the lane change.

5. The vehicle control method of claim 1, wherein determining the congestion level comprises:
calculating a first congestion level at a first timing; and
adding an offset obtained by reflecting a depreciation rate in a second congestion level prior to the first timing to the first congestion level.

6. A vehicle control method comprising:
for a unit section of a certain area that includes a plurality of lanes, setting a default congestion level value to be inversely proportional to an average speed of vehicles traveling on any lane in the unit section;
setting a weight capable of affecting congestion levels of the lanes;
determining a congestion level of each of the lanes in the unit section by adjusting the default value based on the weight;
calculating a congestion level deviation between two lanes randomly selected among the plurality of lanes; and
providing lane change guidance information to at least one of a plurality of vehicles scheduled to enter the unit section to reduce the congestion level deviation, the congestion level deviation being greater than or equal to a predetermined threshold.

7. The vehicle control method of claim 6, wherein setting the weight comprises setting the weight to be inversely proportional to the average speed of the vehicles passing through the unit section.

8. The vehicle control method of claim 6, wherein setting the weight comprises setting the weight to be proportional to the number of the vehicles passing through the unit section.

9. The vehicle control method of claim 6, wherein setting the weight comprises:
identifying a lane blocking event in which one of the plurality of lanes is blocked in the unit section; and
setting a weight of the lane in which the lane blocking event occurs to be higher than weights of remaining lanes of the plurality of lanes.

10. The vehicle control method of claim 9, wherein setting the weight comprises adding a highest congestion level to the lane in which the lane blocking event occurs and adding a lower congestion level as a distance from the lane in which the lane blocking event occurs is increased.

11. The vehicle control method of claim 6, wherein setting the weight comprises setting weights of a lane in which the number of lanes is reduced in the unit section and a merging lane to be large.

12. The vehicle control method of claim 6, wherein setting the weight comprises:
performing artificial intelligence learning of pieces of information about the average speed of the vehicles passing through the unit section, the number of the vehicles passing through the unit section, a lane blocking event in which one of the plurality of lanes is blocked in the unit section, or a lane where the number of lanes is reduced in the unit section and a merging lane; and
extracting the weight.

13. A vehicle control apparatus comprising:
a communication device configured to receive traffic information about a unit section of a certain area including a plurality of lanes;
a congestion level calculation device configured to search for road information stored in a database, determine a congestion level of each of the lanes which belongs to the unit section based on the traffic information and the road information, and calculate a congestion level deviation between two lanes randomly selected from among the lanes; and
a lane change logic device configured to provide lane change guidance information to a vehicle scheduled to enter the unit section to reduce the congestion level deviation when the congestion level deviation is greater than or equal to a predetermined threshold.

14. The vehicle control apparatus of claim 13, wherein the congestion level calculation device is configured to:
set a default value to be inversely proportional to an average speed of the vehicles traveling on any lane in the unit section;
set a weight capable of affecting the congestion level; and
reflect the weight in the default value to calculate the congestion level.

15. The vehicle control apparatus of claim 14, wherein the congestion level calculation device is configured to:
identify a lane blocking event in which one of the plurality of lanes is blocked in the unit section; and
set a weight of the lane in which the lane blocking event occurs to be higher than weights of remaining lanes of the plurality of lanes.

16. The vehicle control apparatus of claim 14, wherein the congestion level calculation device is configured to set weights of a lane in which the number of lanes is reduced in the unit section and a merging lane to be large.

17. The vehicle control apparatus of claim 14, wherein the congestion level calculation device is configured to:
perform artificial intelligence learning of pieces of information about the average speed of the vehicles passing through the unit section, the number of the vehicles passing through the unit section, a lane blocking event in which one of the plurality of lanes is blocked in the unit section, or a lane in which the number of lanes is reduced in the unit section and a merging lane; and
extract the weight.

18. The vehicle control apparatus of claim 13, wherein the lane change logic device is configured to first provide the lane change guidance information to an autonomous vehicle preferentially over a non-autonomous vehicle.

19. The vehicle control apparatus of claim 18, wherein the lane change logic device is configured to:
award a user reward to a driver of the non-autonomous vehicle in response to the driver of the non-autonomous vehicle completing a lane change in response to a request for the lane change; and
first provide the lane change guidance information to a driver with a high score according to the user reward when requesting the driver of the non-autonomous vehicle to make a lane change.

20. The vehicle control apparatus of claim 13, wherein the congestion level calculation device is configured to calculate a first congestion level at a first timing and add an offset obtained by reflecting a depreciation rate in a second congestion level prior to the first timing to the first congestion level.
